(19) United States
(12) Patent Application Publication
(10) Pub. No.: US 2024/0378131 A1
(43) Pub. Date: Nov. 14, 2024

(54) DETERMINING A TARGET POLICY FOR MANAGING AN ENVIRONMENT

(71) Applicant: Telefonaktiebolaget LM Ericsson (publ), Stockholm (SE)

(72) Inventors: Filippo VANNELLA, Stockholm (SE); Jaeseong JEONG, Solna (SE); Alexandre PROUTIERE, Stockholm (SE); Yassir JEDRA, Vallentuna (SE)

(21) Appl. No.: 18/290,926

(22) PCT Filed: Jul. 23, 2021
(86) PCT No.: PCT/SE2021/050748

§ 371 Date: Jan. 22, 2024

(51) Int. Cl. G06F 11/34; G06F 17/12

(52) U.S. Cl. CPC G06F 11/3452; G06F 17/12

(57) ABSTRACT

A computer implemented method is disclosed for determining a target policy for managing an environment. The method includes obtaining a training dataset including records of task performance by the environment during a period of management according to a reference policy, and repeating, until a stopping condition is satisfied, the steps of selecting a record of task performance from the training data set, using the selected record to update an initiated estimate of a linear function mapping an observed environment context and selected action to a predicted value of reward, and checking whether the stopping condition has been satisfied. The method further includes outputting as the target policy a function operable to select for execution in the environment an action which, for a given context, is mapped by the estimate of the linear function at the time the stopping condition is satisfied to the maximum predicted value of reward.

### TECHNICAL FIELD

The present disclosure relates to a method for determining a target policy for managing an environment that is operable to perform a task, and to a method for using a target policy to manage an environment that is operable to perform a task. The methods are performed by a policy node and by a management node respectively. The present disclosure also relates to a policy node, a management node, and to a computer program product configured, when run on a computer, to carry out methods for determining a target policy for managing an environment that is operable to perform a task, and/or for using a target policy to manage an environment that is operable to perform a task.

### BACKGROUND

The Contextual Bandit (CB) setting refers to a decision-making framework in which an agent interacts with an environment by selecting actions to be executed on the environment. The agent learns an optimal policy for action selection by interacting with the environment and collecting a reward signal as a consequence of executing an action when a given context is observed in the environment. The context comprises information about the state of the environment that the agent uses to select an action in accordance with its learned policy.

In the Linear Contextual Bandit (LCB) problem, at time t≥1 an agent observes a context xₜ∈ [symbol] ⊂R^{d} which is drawn independently and identically distributed (i.i.d.) from an unknown probability distribution over the context space, i.e., xₜ˜p [symbol] . The agent is provided with a discrete action set [symbol] ={1, . . . , K}, and a known map for generation of a feature vector from a context and selected action:

$$ϕ : 𝒳 \times ↦ {R}^{d} .$$

The agent selects an action aₜ from [symbol] using a policy, and receives a reward sample:

$${r}_{t} = {ϕ}_{{x}_{t} , {a}_{t}}^{T} θ + {ξ}_{t} ,$$

where ξₜ˜ [symbol] (0, σ²) is a noise sample, and θ∈R^{d} is an unknown coefficient vector. The policy a(⋅): [symbol] → [symbol] is defined as a mapping from contexts to actions to be selected.

While interacting with the environment, a significant amount of data is collected by the agent. This offline data represents a considerable advantage for learning policies in data-driven techniques. In general, learning a policy by direct interaction with the environment carries the risk of reduced short-term reward. This may be highly problematic in some circumstances, as performance of the environment may be degraded to a potentially unacceptable degree during an exploration phase in which the agent tries out different actions in order to learn an optimal policy. Policy learning using offline data avoids this risk.

For offline learning, data is collected by a logging policy that is different from the target policy that is to be trained using the collected data. The collected data is therefore referred to as off-policy data. Learning a new target policy from off-policy data in an offline manner can avoid exploratory actions in an online environment that are the primary cause of unsafe behaviors in online learning.

Formally, a baseline dataset [symbol] _{π}_{₀}={(xᵢ, aᵢ, rᵢ)}ᵢ₌₁^{M} is assumed, which has been collected using a logging policy π₀. The objective is to devise a target or learning policy π∈Π, where, Π is a policy space, in an offline manner from the off-policy dataset D_{π}_{₀} with the objective of maximizing the value of the learning policy π, defined as:

$$V ( π ) = {E}_{x ∼ P ( 𝒳 )} {E}_{a ∼ π ( \cdot \vert x )} {E}_{δ \sim Δ ( \cdot \vert x , a )} [ r ( x , a ) ] = {E}_{π} [ r ( x , a ) ] .$$

As the off-policy data are collected by the logging policy π₀, they cannot be used directly to estimate the value of the learning policy π, as the learning policy will not always select the same action as the logging policy, given the same observed environment context. This problem can be addressed by using a value estimator based on V such as the Inverse Propensity Scoring (IPS) or Direct Method (DM) estimators.

Best Policy Identification (BPI) is a technique aiming to determine the best policy:

$${a}_{θ}^{★} ( x ) ∈ arg {max}_{a ∈ 𝒜} {θ}^{T} {ϕ}_{x , a} ,$$

$$for all$$

$$x ∈ 𝒳 .$$

An off-policy BPI process is characterized by two elements:
1) Stopping rule: this rule controls the end of the algorithm execution and defines a stopping time τ such that P_{θ}[τ<∞]=1.
2) Recommendation rule: this rule returns, at round τ, a recommended best arm, or action, âₜ(x), for all x∈ [symbol] .

Off-policy estimation suffers from issues with reliability. Previous work in the off-policy setting has focused on learning a policy that maximizes the policy value based on off-policy reward estimators, as discussed above. Such estimators are often unreliable, especially when data are biased or contain a significant amount of noise. These estimators also offer relatively weak guarantees on the quality of the learned policy, owing to the generality of the assumptions on the reward structure.

Another challenge associated with off-policy estimation is determining the correct stopping time. Existing solutions for off-policy estimation generally learn a policy from a given dataset. However, in live operations, data is continually generated and accumulated in real-time using the logging policy. In this scenario, an important task is to determine the stopping time at which the best estimate policy is returned, i.e. when to stop using the deployed logging policy, and switch to the trained best estimated policy. If the switch is too early, and the accumulated data was not sufficient to train an optimal policy, then environment performance will be degraded owing to poor decisions resulting from insufficient training for the policy. If the switch is too late, an opportunity to optimize environment performance with the trained policy is wasted, as the environment maintains management under the logging policy, and consequent suboptimal performance, for an unnecessarily extended period. Existing methods for off-policy learning do not offer reliable methods for determining the stopping time.

### SUMMARY

It is an aim of the present disclosure to provide methods, nodes, and a computer program product which at least partially address one or more of the challenges discussed above. It is a further aim of the present disclosure to provide methods, nodes and a computer program product that cooperate to determine, in a manner that is safe for a managed environment, a target policy that is optimal by some measure, resulting in improved performance of its task by an environment that is managed according to the target policy.

According to a first aspect of the present disclosure, there is provided a computer implemented method for determining a target policy for managing an environment that is operable to perform a task. The method, performed by a policy node, comprises obtaining a training dataset comprising records of task performance by the environment during a period of management according to a reference policy, wherein each record of task performance comprises an observed context for the environment, an action selected for execution in the environment by the reference policy on the basis of the observed context, and a reward value indicating an observed impact of the selected action on task performance by the environment. The method further comprises repeating, at a plurality of time steps until a stopping condition is satisfied, the steps of (i) selecting a record of task performance from the training data set, (ii) using the observed context, selected action, and reward from the selected record to update an initiated estimate of a linear function mapping observed context and selected action to a predicted value of reward, and (iii) checking whether the stopping condition has been satisfied. The method further comprises outputting as the target policy a function operable to select for execution in the environment an action which, for a given context, is mapped by the estimate of the linear function at the time the stopping condition is satisfied to the maximum predicted value of reward. The stopping condition comprises the probability that an error condition for the linear function is satisfied descending below a maximum acceptability probability threshold, and the error condition comprises an action selected using the current estimate of the linear function being separated by more than an error threshold from an optimal action.

According to another aspect of the present disclosure, there is provided a computer implemented method for using a target policy to manage an environment that is operable to perform a task. The method, performed by a management node, comprises obtaining the target policy from a policy node, wherein the target policy has been determined using a method according to examples of the present disclosure. The method further comprises receiving an observed environment context from an environment node, using the target policy to select, based on the received observed context and from a set of possible actions for the environment, an action for execution in the environment, and causing the selected action to be executed in the environment. The target policy selects the action that is predicted to cause the highest reward value to be observed in the environment, the reward value comprising an observed impact of the selected action on task performance by the environment.

According to another aspect of the present disclosure, there is provided a computer program product comprising a computer readable medium, the computer readable medium having computer readable code embodied therein, the computer readable code being configured such that, on execution by a suitable computer or processor, the computer or processor is caused to perform a method according to any one or more of the aspects or examples of the present disclosure.

According to another aspect of the present disclosure, there is provided a policy node for determining a target policy for managing an environment that is operable to perform a task. The policy node comprises processing circuitry configured to cause the policy node to obtain a training dataset comprising records of task performance by the environment during a period of management according to a reference policy, wherein each record of task performance comprises an observed context for the environment, an action selected for execution in the environment by the reference policy on the basis of the observed context, and a reward value indicating an observed impact of the selected action on task performance by the environment. The processing circuitry is further configured to cause the policy node to repeat, at a plurality of time steps until a stopping condition is satisfied, the steps of (i) selecting a record of task performance from the training data set, (ii) using the observed context, selected action, and reward from the selected record to update an initiated estimate of a linear function mapping observed context and selected action to a predicted value of reward, and (iii) checking whether the stopping condition has been satisfied. The processing circuitry is further configured to cause the policy node to output as the target policy a function operable to select for execution in the environment an action which, for a given context, is mapped by the estimate of the linear function at the time the stopping condition is satisfied to the maximum predicted value of reward. The stopping condition comprises the probability that an error condition for the linear function is satisfied descending below a maximum acceptability probability threshold, and the error condition comprises an action selected using the current estimate of the linear function being separated by more than an error threshold from an optimal action.

According to another aspect of the present disclosure, there is provided a management node for using a target policy to manage an environment that is operable to perform a task. The management node comprises processing circuitry configured to cause the management node to obtain the target policy from a policy node, wherein the target policy has been determined using a method according to examples of the present disclosure. The processing circuitry is further configured to cause the management node to receive an observed environment context from an environment node, use the target policy to select, based on the received observed context and from a set of possible actions for the environment, an action for execution in the environment, and cause the selected action to be executed in the environment. The target policy selects the action that is predicted to cause the highest reward value to be observed in the environment, the reward value comprising an observed impact of the selected action on task performance by the environment.

Aspects of the present disclosure thus provide methods and nodes for off-policy learning of a target policy for managing an environment. Methods proposed herein avoid the risks of live learning in an environment, without incurring the issues with reliability that are associated with value estimation in an off-policy setting. Methods proposed herein also provide a stopping condition which can be used to identify when an optimal policy estimation has been reached. As discussed in greater detail below, performance of the methods disclosed herein has been validated on communication network data for the task of Remote Electrical Tilt (RET) optimization in 4G LTE networks, and experimental results show that the resulting policy is provably optimal in terms of sample complexity, achieving up to a multiplicative constant the theoretical lower bound on sample complexity.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a computer implemented method for determining a target policy for managing an environment that is operable to perform a task;

FIGS. 2a to 2d show a flow chart illustrating process steps in another example of computer implemented method for determining a target policy for managing an environment that is operable to perform a task;

FIGS. 3a and 3b illustrate examples of how the methods of FIGS. 1, 2 and 4 may be applied to different technical domains of a communication network;

FIG. 4 shows a flow chart illustrating process steps in a computer implemented method for using a target policy to manage an environment that is operable to perform a task;

FIG. 5 is a flow chart illustrating implementation of the method of FIG. 1 or FIG. 2 as a process flow;

FIGS. 6 and 7 are block diagrams illustrating functional modules in examples of a policy node;

FIGS. 8 and 9 are block diagrams illustrating functional modules in examples of a management node;

FIG. 10 shows experimental results relating to a test use case for the methods of the present disclosure;

FIG. 11 illustrates optimal action recommendations of a target policy for the use case of FIG. 10; and

FIG. 12 shows results for the Lower bound and sample complexity for the experimental validation of FIGS. 10 and 11.

### DETAILED DESCRIPTION

Examples of the present disclosure provide methods and nodes for off-policy learning. In some examples, the methods may be implemented as an (ε, δ)-Probably Approximately Correct, ((ε, δ)-PAC) algorithm, that is an algorithm that satisfies:

$$∀ θ ∈ {R}^{d} ,$$

$${P}_{θ} ( ∀ x ∈ 𝒳 , {θ}^{T} ( {ϕ}_{x , {a}_{θ}^{★} ( x )} - {ϕ}_{x , {\hat{a}}_{τ} ( x )} ) < ε ) \geq 1 - δ$$

$$and$$

$${P}_{θ} [ τ < ∞ ] = 1.$$

The goal of a (ε, δ)-PAC algorithm is to output a policy â_{z}(x) that is ε-correct (that is within an error threshold ε of correct) on all contexts with probability 1−δ and with finite sample complexity. In the off-policy case, it is assumed there exists a fixed sampling rule, i.e., there exists an α: [symbol] → [symbol] such that at time t≥1 an agent observes xₜ, and [symbol] selects aₜ˜αₓ. An optimal (ε, δ)-PAC algorithm identifies the best policy using a stopping rule that matches the theoretical lower bound on the expected sample complexity E_{θ}[τ]≳σ²T^{θ} log(1/δ), where T^{θ} is a problem dependent complexity term. Define the set of ε-optimal arms as:

$${𝒜}_{ε} ( θ , x ) = \{ a ∈ 𝒜 : {θ}^{T} ( {ϕ}_{x , {a}_{θ}^{★} ( x )} - {ϕ}_{x , a} ) < ε \}$$

and for a∉ [symbol] _{E}(θ, x), the set:

$${𝒜}_{ε} ( θ , x , a ) = \{ b ∈ {𝒜}_{ε} ( θ , x ) : {θ}^{T} ( {ϕ}_{x , b} - {ϕ}_{x , a} ) \geq ε \}$$

The characteristic time, approximation of the lower bound on the sample complexity is then defined as:

$${T}_{ε , θ}^{★} = {max}_{x ∈ 𝒳} {max}_{a ∉ {𝒜}_{ε} ( θ , x )} {max}_{b ∈ {𝒜}_{ε} ( θ , x , a )} \frac{2 {\vert {ϕ}_{x , b} - {ϕ}_{x , a} \vert}_{{A ( α )}^{- 1}}^{2}}{{( {θ}^{T} ( {ϕ}_{x , b} - {ϕ}_{x , a} ) + ε )}^{2}}$$

Examples of the present disclosure enable provably optimal off-policy best policy identification in contextual bandit models with linear reward structure. This learning is based on data generated using a sub-optimal logging, or reference, policy deployed into an environment. The data may be obtained in batches or as a live stream generated in real-time in the online environment. In particular, examples of the present disclosure provide a method for modeling an off-policy optimization task as an LCB problem, as demonstrated with reference to the use cases discussed below. The methods proposed herein incorporate a recommendation policy and a stopping rule for off-policy best policy identification, enabling automated identification of the optimal time to stop using a reference policy for online management, and switch to using the determined target policy.

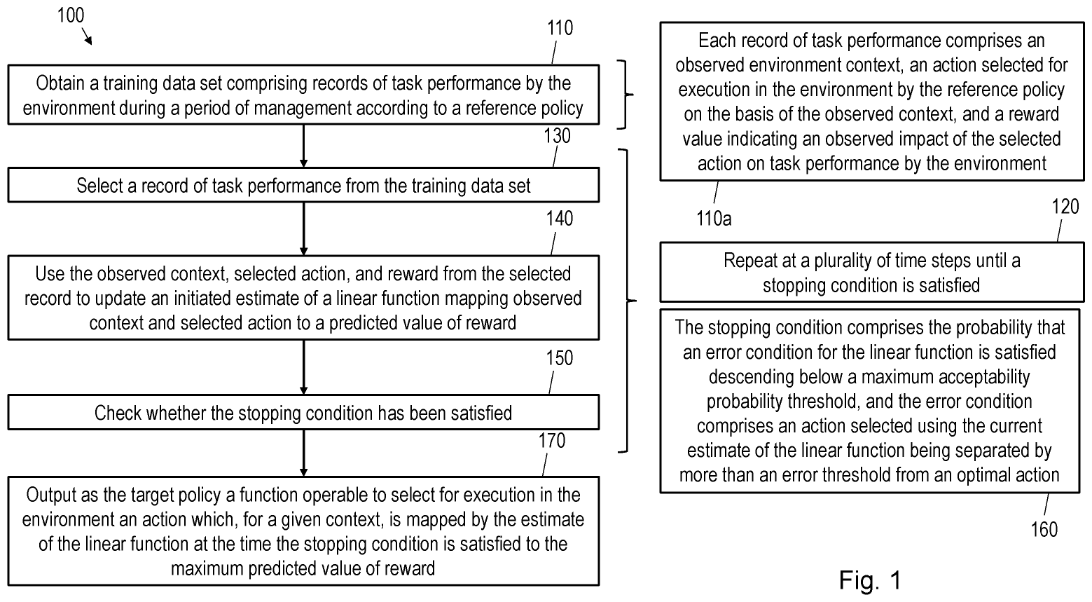

FIG. 1 is a flow chart illustrating process steps in a computer implemented method 100 for determining a target policy for managing an environment that is operable to perform a task. The environment may comprise a part of a communication network or an industrial or manufacturing environment such as a power plant, turbine, solar array, factory, production line, reaction chamber, item of automated equipment, etc. The environment may comprise a commercial, residential or office space such as a room, a floor, a building, etc. In other examples, the environment may comprise a vehicle operable to advance over terrain. In the case of a commination network environment, the task performed by the environment may comprise one or more aspects of provision of communication network services. For example, the environment may comprise a cell, a cell sector, or a group of cells of a commination network, and the task may comprise provision of Radio Access Network (RAN) services to wireless devices connecting to the network from within the environment. In other examples, the environment may comprise a network slice, or a part of a transport or core network, in which case the task may be to provide end to end network services, core network services such as mobility management, service management etc., network management services, backhaul services or other services to wireless devices, to other parts of the communication network, to network traffic originating from wireless devices, to application services using the network, etc.

The method 100 is performed by a policy node, which may comprise a physical or virtual node, and may be implemented in a computing device or server apparatus and/or in a virtualized environment, for example in a cloud, edge cloud or fog deployment. The policy node may for example be implemented in a core network of a communication network. The policy node may encompass multiple logical entities, as discussed in greater detail below, and may for example comprise a Virtualized Network Function (VNF).

Referring to FIG. 1, the method 100 comprises, in step 110, obtaining a training dataset comprising records of task performance by the environment during a period of management according to a reference policy. The reference policy may be a rules-based policy, for example designed by a domain expert according to existing domain knowledge. In other examples, the reference policy may be a data-based policy such as a Machine Learning model, or it may be a hybrid combination of rules-based and data-based decision making. As illustrated at 110a, each record of task performance comprises an observed context for the environment, an action selected for execution in the environment by the reference policy on the basis of the observed context, and a reward value indicating an observed impact of the selected action on task performance by the environment.

An observed context for an environment comprises any measured, recorded or otherwise observed information about the state of the environment. An observed context may therefore comprise one or more Key Performance Indicators (KPIs) for the environment. If the environment is an environment within a communication network, such as a cell of a cellular network, a cell sector, a group of cells, a geographical region, transport network, core network, network slice, etc., then an observed context for an environment may therefore comprise one or more network KPIs, information about a number of wireless devices connecting to the communication network in the environment, etc. The action selected for execution in the environment may be any configuration, management or other action which impacts performance of the environment task. This may comprise setting one or more values of controllable parameters in the environment for example. The reward value indicates an observed impact of the selected action on task performance by the environment. This may comprise a change in one or more KPI values following execution of the action, or any other value, combination of values etc. which provide an indication of how the selected action has impacted the ability of the environment to perform its task. For example, in the case of an environment comprising a cell of a RAN, the reward value may comprise a function of network coverage, quality and capacity parameters.

It will be appreciated that the records of task performance by the environment thus provide an indication of how the environment has been managed by the reference policy. The records illustrate, for each action executed on the environment, the information on the basis of which the reference policy selected the action (the context), the action selected, and the outcome of the selected action for task performance (the reward value). Determination of the target policy according to the method 100 is performed using the obtained training data in subsequent method steps, and is consequently performed as off-policy learning.

The step 110 of obtaining the training dataset may comprise obtaining one or more batches of historical records or may comprise obtaining the records in a substantially continuous manner while the reference policy is used online in the environment.

The method 100 then comprises, as illustrated at step 120, repeating at each of a plurality of time steps the steps 130, 140 and 150, until a stopping condition is satisfied. The stopping condition is discussed in greater detail below.

Step 130 comprises selecting a record of task performance from the training data set, and step 140 comprises using the observed context, selected action, and reward from the selected record to update an initiated estimate of a linear function mapping observed context and selected action to a predicted value of reward. Step 150 comprises checking whether the stopping condition has been satisfied. As illustrated at step 160, the stopping condition comprises the probability that an error condition for the linear function is satisfied descending below a maximum acceptability probability threshold. The error condition comprises an action selected using the current estimate of the linear function being separated by more than an error threshold from an optimal action. The maximum acceptability probability threshold and the error threshold may be predetermined, and may be set according to a particular environment and task.

In step 170, the method 100 comprises outputting as the target policy a function operable to select for execution in the environment an action which, for a given context, is mapped by the estimate of the linear function at the time the stopping condition is satisfied to the maximum predicted value of reward.

It will be appreciated that the method 100 may be understood as both performing policy generation, by updating an estimate of a linear reward model and outputting a policy that selects actions that correspond to maximum predicted reward, and imposing a stopping rule to determine the estimated linear function that is to be used in the final target policy. As discussed in greater detail below, the resulting target policy is provably optimal in terms of sample complexity, owing to the use of the stopping condition.

The method 100 thus offers improved management of an environment, through enabling an optimal policy to be trained in an offline, and consequently safe, manner. The improved reliability offered by the determined target policy ensures improved performance of the environment when managed by the target policy, without incurring the risks of online target policy training. In addition, and particularly in the case of training data obtained in a substantially continuous manner, the stopping condition of the method 100 ensures that transition from a reference policy to the determined target policy can be performed at the optimal time. This optimal transition time avoids an early transition to a not yet optimal target policy, and also avoids unnecessary continued use of the reference policy when an optimal target policy has already been identified.

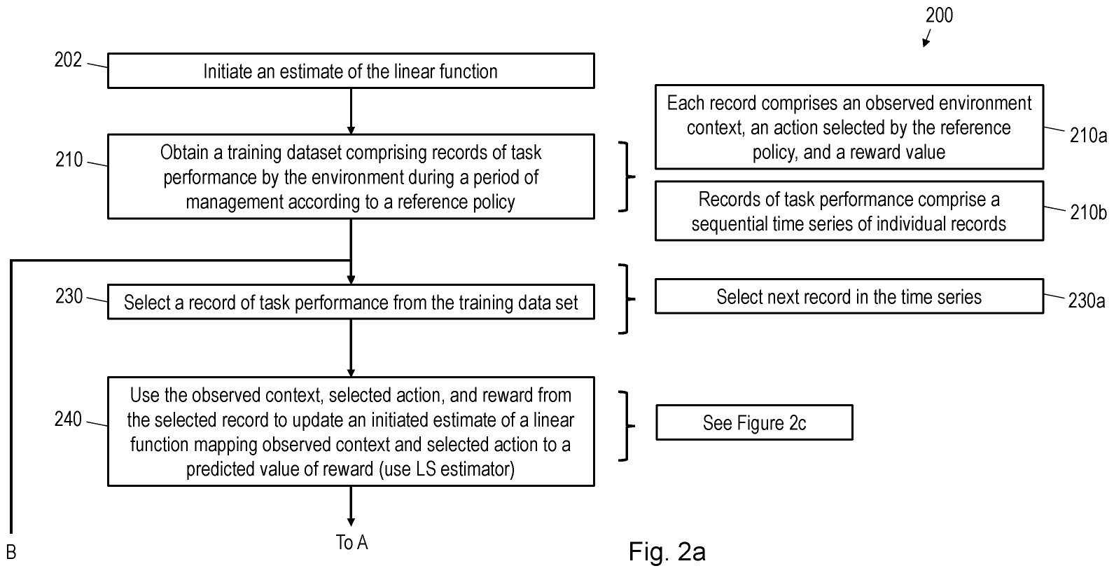

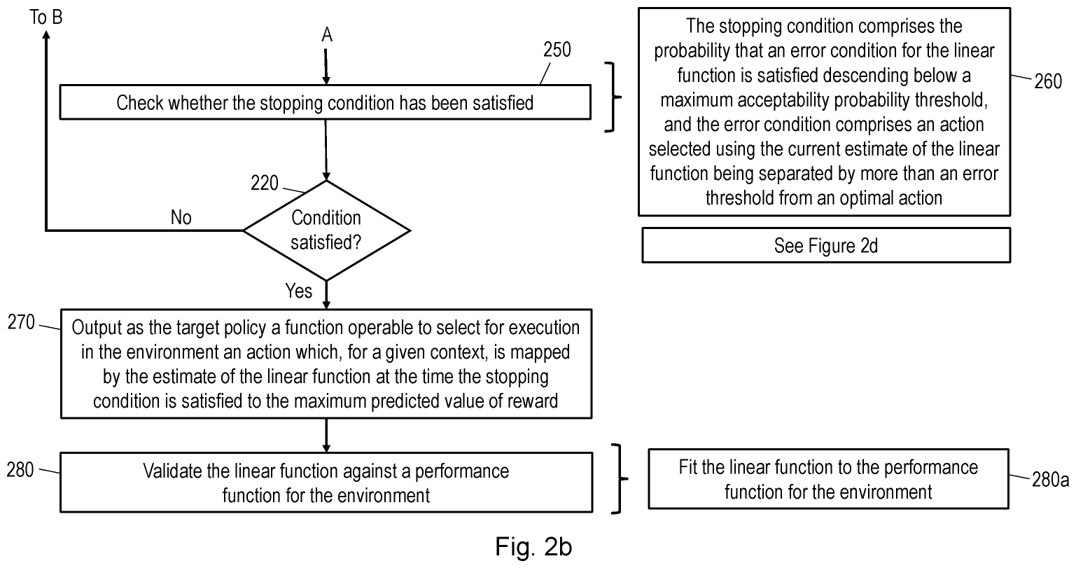

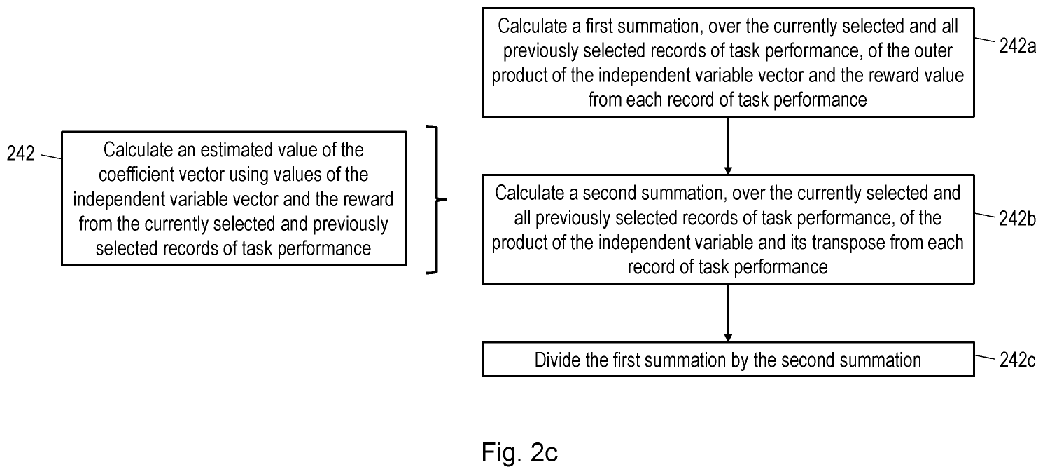

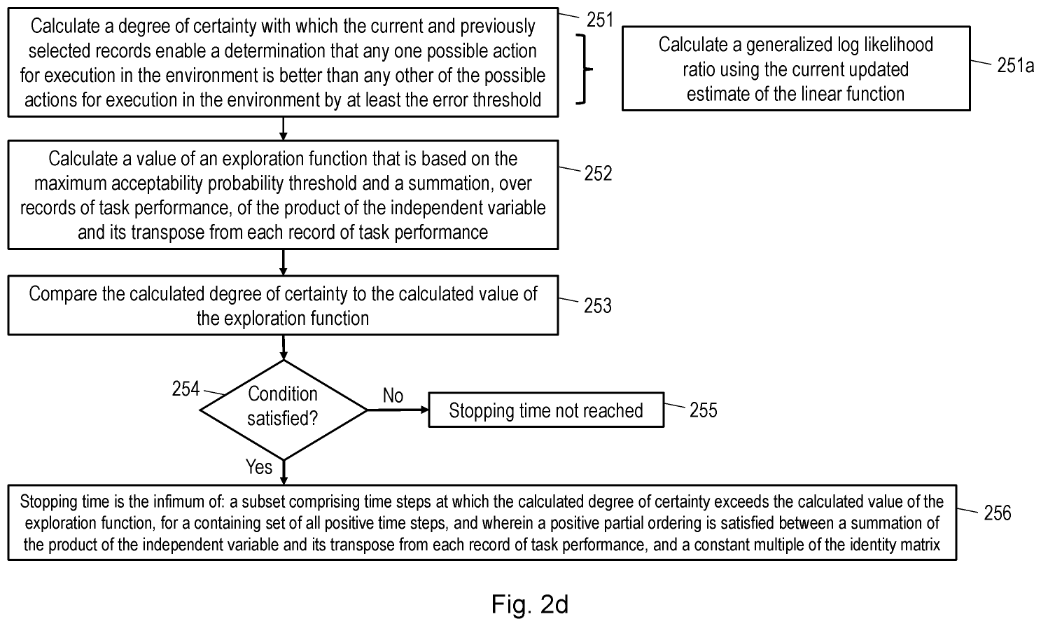

FIGS. 2a to 2d show flow charts illustrating process steps in a further example of method 200 for determining a target policy for managing an environment that is operable to perform a task. The method 200 provides various examples of how the steps of the method 100 may be implemented and supplemented to achieve the above discussed and additional functionality. It will be appreciated that much of the detail described above with reference to the method 100 also applies to the method 200. For example, the nature of the environment, the observed environment context, the reward value, and possible actions for execution in the environment may all be substantially as described above with reference to FIG. 1. As for the method 100, the method 200 is performed by a policy node, which may be a physical or virtual node, and which may encompass multiple logical entities.

Referring initially to FIG. 2a, in a first step 202 the policy node initiates an estimate of a linear function mapping observed context and selected action to a predicted value of reward. The linear function is thus a linear model of reward in the environment, generating a prediction of reward value that will be received based on the observed context from the environment and the selected action for execution in the environment. The model is a linear model, and may consequently comprise an independent variable vector and a coefficient vector, as discussed in greater detail below. In some examples, the step 202 may further comprise selecting values for a maximum acceptability probability threshold, an error threshold, a constant for use in calculation of the stopping condition, and any other constant values that may be used in the subsequent method steps.

In step 210, the policy node obtains a training dataset comprising records of task performance by the environment during a period of management according to a reference policy. As illustrated at 210a, each record of task performance comprises an observed context for the environment, an action selected for execution in the environment by the reference policy on the basis of the observed context, and a reward value indicating an observed impact of the selected action on task performance by the environment. As illustrated at 210b, the obtained records of task performance may comprise a sequential time series of individual records. For example, if the reference policy has been used to select actions for execution in the environment at consecutive time steps, then the records of observed context, selected action and reward value will form a time series reflecting management of the environment by the reference policy. The elements of this time series (the individual records) may be obtained in a batch or in a substantially continuous manner during online use of the reference policy.

The policy node then repeats steps 230, 240 and 250 as described below at each of a plurality of time steps until a stopping condition is satisfied.

At a given time step, the policy node first selects a record of task performance from the training data set in step 230. As illustrated at 230a, this may comprise selecting a next record in the time series. The first selected record may be the earliest record in the dataset or may be any record selected from the time series, and subsequent selections may then follow the time series sequentially.

In step 240, the policy node then uses the observed context, selected action, and reward from the selected record to update an initiated estimate of the linear function mapping observed context and selected action to a predicted value of reward. This may comprise using a Least Squares estimator to update the initiated estimate of the linear function, for example by estimating an updated value of the coefficient vector of the linear function, as discussed below, and illustrated in FIG. 2c.

FIG. 2c illustrates one example of how the policy node may use the observed context, selected action, and reward from the selected record to update an initiated estimate of the linear function. In the example of FIG. 2c, the linear function mapping observed context and selected action to a predicted value of reward comprises an independent variable vector that is a function of the observed context and selected action, and a coefficient vector of the independent variable vector. The function of the observed context and selected action that defines the independent variable vector is in some examples an outer product.

Referring to FIG. 2c, and as discussed above, updating an estimate of the linear function may comprise in step 242 calculating an estimated value of the coefficient vector using values of the independent variable vector and the reward from the currently selected and previously selected records of task performance. This may be achieved by performing steps 242a to 242c. In step 242a, the policy node calculates a first summation, over the currently selected and all previously selected records of task performance, of the outer product of the independent variable vector and the reward value from each record of task performance. In step 242b, the policy node calculates a second summation, over the currently selected and all previously selected records of task performance, of the product of the independent variable and its transpose from each record of task performance. In step 242c, the policy node divides the first summation by the second summation. It will be appreciated that for time steps s from 1 to a current time step t, a content x, a selected action a, an independent variable vector ϕₓ_{ₛ}_{,a}_{ₛ}, a reward value r, and a coefficient vector θ, the steps 242a to 242c above may be implemented by calculating an estimated value \hat{θ}ₜ of the coefficient vector θₜ at the current time step t as:

$${\hat{θ}}_{t} = {( {\sum }_{s = 1}^{t} {ϕ}_{{x}_{s} , {a}_{s}} {ϕ}_{{x}_{s} , {a}_{s}}^{T} )}^{- 1} ( {\sum }_{s = 1}^{t} {ϕ}_{{x}_{s} , {a}_{s}} {r}_{s} )$$

Referring now to FIG. 2b, after using the observed context, selected action, and reward from the selected record to update an initiated estimate of the linear function in step 240, the policy node then checks in step 250 whether the stopping condition has been satisfied. As discussed above and illustrated at 260, the stopping condition comprises the probability that an error condition for the linear function is satisfied descending below a maximum acceptability probability threshold. The error condition comprises an action selected using the current estimate of the linear function being separated by more than an error threshold from an optimal action.

In effect, the error threshold defines a level of intolerance that is acceptable for the target policy, as illustrated in the following discussion. Considering a current version of the target policy, which is based on the current version of the linear function estimating reward, this current version of the target policy may be considered to identify, for a given context, an action a₁ as being optimal (that is predicted to result in the highest or greatest reward). If action a₁ is not in fact the optimal action, then the error threshold defines whether or not the target policy is still considered to have made a correct choice. The error threshold is a threshold on the difference between the reward of action a₁, selected by the target policy, and the reward of the action that in fact generates the maximum reward for the given context (the correct best action). If the difference between the reward of a₁ and the reward of the correct best action is not greater than the error threshold, then the target policy is still considered to have made a correct choice. The error condition of the linear function is satisfied when this difference in reward is greater than the error threshold. The maximum acceptability probability threshold is a threshold on the probability that the error condition will be satisfied. When the probability that the error condition will be satisfied descends below the maximum acceptability probability threshold, then the stopping condition is satisfied.

It will be appreciated that the value of the error threshold thus defines how close to optimal the target policy is required to be. The maximum acceptability probability threshold defines the level of certainty that is required by the method regarding the obtained accuracy of the target policy.

FIG. 2d illustrates a series of sub steps that may be performed in order to carry out the check of step 250. Referring now to FIG. 2d, the policy node initially, in step 251, calculates a degree of certainty with which the current and previously selected records enable a determination, using the current updated estimate of the linear function, that any one possible action for execution in the environment is better than any other of the possible actions for execution in the environment by at least the error threshold. As illustrated at 251a, this may comprise calculating a generalized log likelihood ratio using the current updated estimate of the linear function.

In step 252, the policy node then calculates a value of an exploration function that is based on the maximum acceptability probability threshold and a summation, over the currently selected and all previously selected records of task performance, of the product of the independent variable and its transpose from each record of task performance. In step 253, the policy node compares the calculated degree of certainty to the calculated value of the exploration function.

The stopping condition is satisfied when:
(i) the calculated degree of certainty exceeds the calculated value of the exploration function, and
(ii) a positive partial ordering is satisfied between a summation, over the currently selected and all previously selected records of task performance, of the product of the independent variable and its transpose from each record of task performance, and a constant multiple of the identity matrix. The constant multiple can be selected according to operational priorities.

These two requirements for satisfaction of the stopping condition are checked by the policy node at step 254. If the requirements are not both satisfied, then the stopping condition has not yet been reached, as illustrated at step 255. If both requirements are satisfied, then the stopping condition has been reached, and the stopping time is the time step at which the stopping condition is satisfied. As illustrated at 256, the stopping time can be defined as the infimum of:
(i) a subset comprising time steps at which the calculated degree of certainty exceeds the calculated value of the exploration function, for a containing set of all positive time steps; and
(ii) wherein a positive partial ordering is satisfied between a summation, over the currently selected and all previously selected records of task performance, of the product of the independent variable and its transpose from each record of task performance, and a constant multiple of the identity matrix.

A mathematical treatment of the stopping condition is provided below, with reference to implementation of methods according to the present disclosure.

Referring again to FIG. 2b, after checking in step 250 whether the stopping condition has been satisfied, the policy node then takes different actions according to the result of the check. If the stopping condition has not been reached, then the policy node returns to step 230, and selects a next record of task performance from the training data step.

If the stopping condition has been satisfied, then the policy node outputs as the target policy a function operable to select for execution in the environment an action which, for a given context, is mapped by the estimate of the linear function at the time the stopping condition is satisfied to the maximum predicted value of reward.

In step 280, the policy node may validate the linear function against a performance function for the environment. This may comprise, as illustrated at 180a, comparing the linear function to the performance function for the environment, and/or fitting the linear function to the performance function. It will be appreciated that the performance function may be of any form. The performance function may for example be based on any one or more environment KPIs, and may be tuned according to operator priorities for the weighting given to particular KPIs. In some examples, Mean Squared Error or R-squared may be used to check the fitness of the linear model.

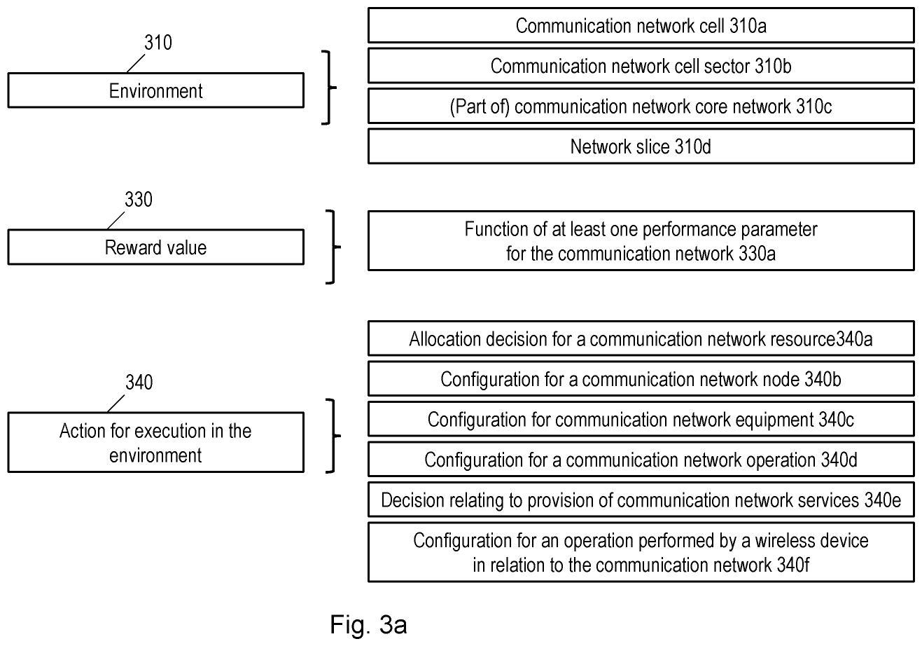

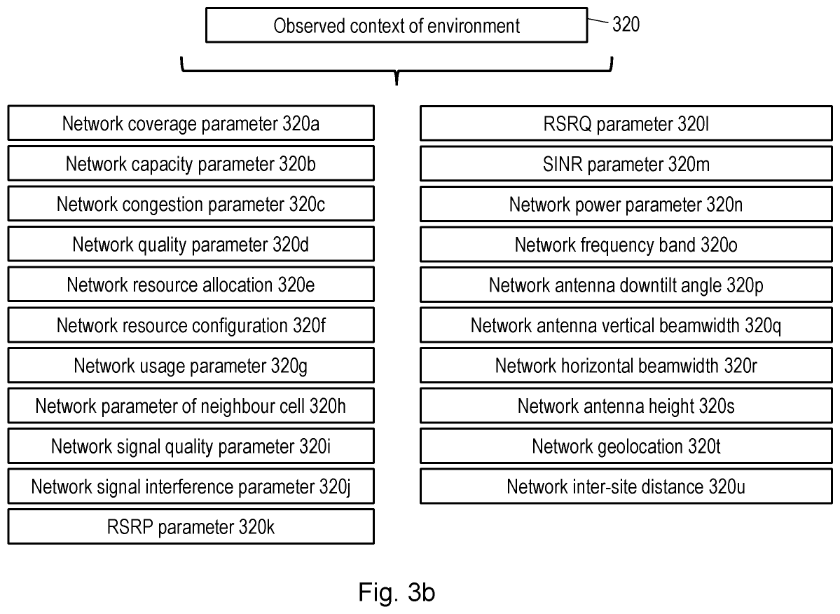

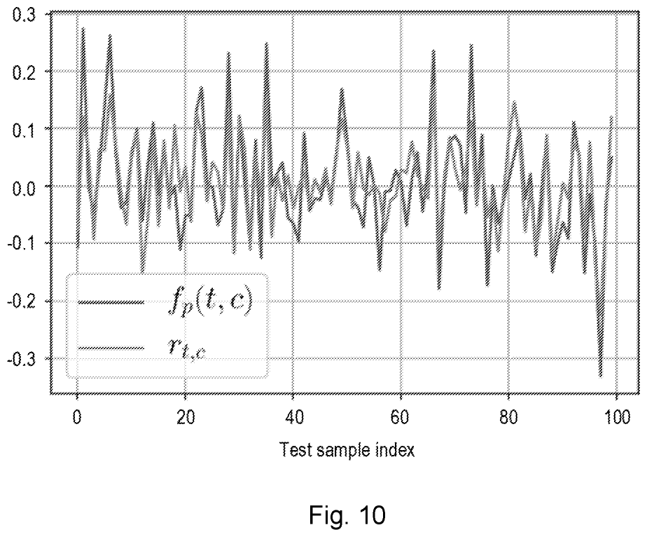

FIGS. 3a and 3b illustrate different examples of how the methods 100 and 200 may be applied to different technical domains of a communication network. A more detailed discussion of example use cases is provided below, for example with reference to FIGS. 10 to 12, however FIGS. 3a and 3b provide an indication of example environments, contexts, actions, and rewards etc. for different technical domains of a communication network. It will be appreciated that an environment within a communication network, and the technical domains illustrated in FIGS. 3a and 3b are merely for the purpose of illustration, and application of the methods 100 and 200 to other environments and technical domains may be envisaged.

Referring initially to FIG. 3a, an environment 310 may comprise at least one of a cell of a communication network 310a, a cell sector of a communication network 310b, at least a part of a core network of a communication network 310c, or a slice of a communication network 310d. The task that the environment is operable to perform may comprise provision of communication network services.

Referring now to FIG. 3b, an observed environment context 320 may comprise at least one of:
a value of a network coverage parameter 320a;
a value of a network capacity parameter 320b;
a value of a network congestion parameter 320c;
a value of a network quality parameter 320d;
a current network resource allocation 320e;
a current network resource configuration 320f;
a current network usage parameter 320g;
a current network parameter of a neighbor communication network cell 320h;
a value of a network signal quality parameter 320i;
a value of a network signal interference parameter 320j;
a value of a Reference Signal Received Power, RSRP parameter 320k;
a value of a Reference Signal Received Quality, RSRQ, parameter 320l;
a value of a network signal to interference plus noise ratio, SINR, parameter 320m;
a value of a network power parameter 320n;
a current network frequency band 3200;
a current network antenna down-tilt angle 320p;
a current network antenna vertical beamwidth 320q;
a current network antenna horizontal beamwidth 320r;
a current network antenna height 320s;
a current network geolocation 320t;
a current network inter-site distance 320u.

It will be appreciated that many of the parameters listed above and illustrated in FIG. 3b comprise observable or measurable parameters, including KPIs of the network, as opposed to configurable parameters that may be controlled by a network operator. In the case of an environment comprising a cell of a communication network, the observed context for the cell may include one or more of the parameters listed above as measured or observed for the cell in question and for one or more neighbor cells of the cell in question.

Referring again to FIG. 3a, the reward value 330 indicating an observed impact of the selected action on task performance by the environment may comprise a function of at least one performance parameter for the communication network 330a.

An action 340 for execution in the environment may comprise at least one of: an allocation decision for a communication network resource 340a;
a configuration for a communication network node 340b;
a configuration for communication network equipment 340c;
a configuration for a communication network operation 340d;
a decision relating to provision of communication network services for a wireless device 340e;
a configuration for an operation performed by a wireless device in relation to the communication network 340f.

Specific examples of configuration for a communication network node may include RET angle adjustment, transmit power, p0 value, horizontal sector shape, etc.

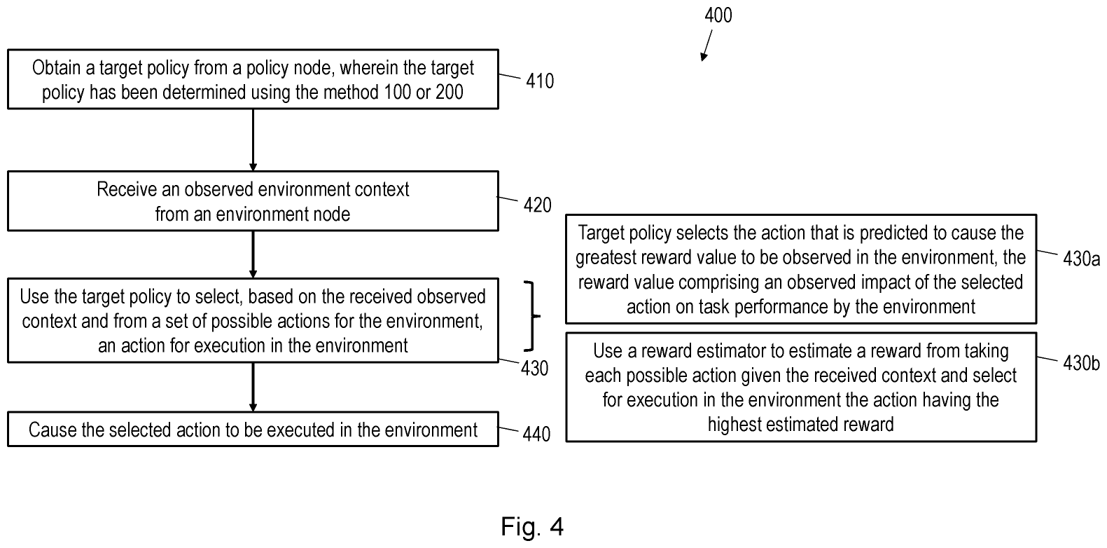

The methods 100 and 200 may be complemented by a computer implemented method 400 for using a target policy to manage an environment that is operable to perform a task, as illustrated in FIG. 4. The method 400 is performed by a management node, which may comprise a physical or virtual node, and may be implemented in a computing device, server apparatus and/or in a virtualized environment, for example in a cloud, edge cloud or fog deployment. When managing a communication network environment, the management node may comprise or be instantiated in any part of a logical core network node, network management center, network operations center, Radio Access Network node etc. A Radio Access Network Node may comprise a base station, eNodeB, gNodeB, or any other current of future implementation of functionality facilitating the exchange of radio network signals between nodes and/or users of a communication network. Any communication network node may itself be divided between several logical and/or physical functions, and any one or more parts of the management node may be instantiated in one or more logical or physical functions of a communication network node. The management node may therefore encompass multiple logical entities, as discussed in greater detail below The method 400 involves using a target policy that has been determined according to examples of the methods 100, 200 to manage an environment. It will be appreciated that much of the detail described above with reference to the methods 100 and 200 also applies to the method 400. For example, the nature of the environment, the observed environment context, the reward value, and possible actions for execution in the environment may all be substantially as described above with reference to FIG. 1. It will also be appreciated that by virtue of having been determined using a method according to the present disclosure, the target policy used in the method 400 offers all of the advantages discussed above relating to safety and optimal policy performance, and consequently improved environment task performance. In some examples of the method 300, additional pre-processing steps may be carried out, including for example normalizing features of the received observed context.

Referring to FIG. 4, in a first step 410 the method 400 comprises obtaining the target policy from a policy node, wherein the target policy has been determined using a method according to examples of the present disclosure. The method 400 then comprises receiving an observed environment context from an environment node in step 420. The environment node may be any physical or virtual node comprising functionality operable to provide an environment context. In step 430, the method 400 comprises using the target policy to select, based on the received observed context and from a set of possible actions for the environment, an action for execution in the environment. As illustrated at 430a, the target policy selects the action that is predicted to cause the highest or greatest reward value to be observed in the environment, the reward value comprising an observed impact of the selected action on task performance by the environment. The method then comprises causing the selected action to be executed in the environment in step 440.

As illustrated in FIG. 4, the step of using the target policy to select, based on the received observed context and from a set of possible actions for the environment, an action for execution in the environment may first comprise, in step 430b, using a reward estimator of the target policy to estimate a reward from taking each possible action given the received context, and then selecting for execution in the environment the action having the highest estimated reward in step 430c. The reward estimator of the target policy may comprise the linear function discussed above, which maps environment context and possible action to a predicted reward value.

For different examples of how the method 400 may be applied to different technical domains of a communication network, reference to made to the examples set out in FIGS. 3a and 3b, and discussed above. It will be appreciated that an environment within a communication network, and the technical domains illustrated in FIGS. 3a and 3b are merely for the purpose of illustration, and application of the method 400 to other environments and technical domains may be envisaged.

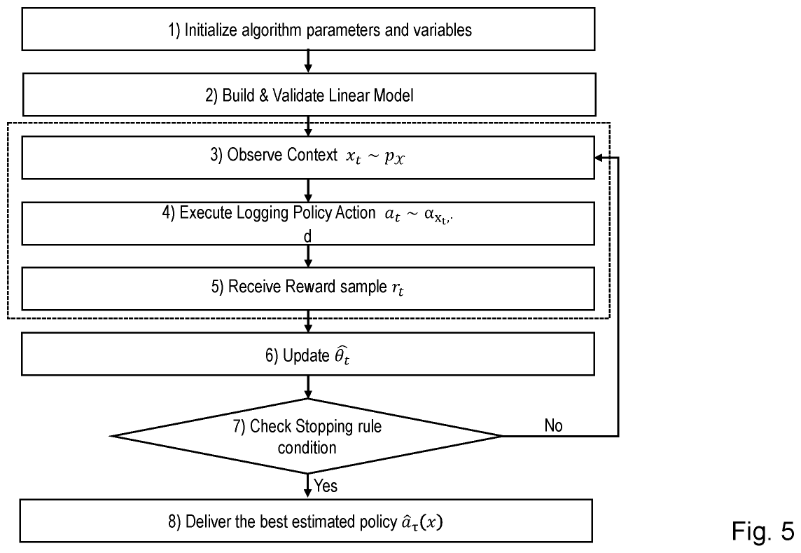

FIGS. 1 to 4 discussed above provide an overview of methods which may be performed according to different examples of the present disclosure. There now follows a detailed discussion of how different process steps illustrated in FIGS. 1 to 4 and discussed above may be implemented according to an example process flow, illustrated in FIG. 5. The process flow assumes that the environment is currently or has been managed using a reference or logging policy, as a consequence of which training data is available in the form of records of observed environment context, selected action and obtained reward.

Referring to FIG. 5, the methods and 200 may be implemented as a process flow comprising the following steps:
1) Initialize algorithm parameters and variables (step 202 of method 200). The parameters and variables for initialization may include the values of the constants c and u discussed below, an initial estimate of the coefficient vector θ of the linear function, and the values of the error threshold ε and the maximum acceptability probability threshold δ. As discussed above, the selected values for ε and δ tune the accuracy and certainty of the process. Thus, considering the process as a PAC algorithm, they define the probability and the approximation of the Probably Approximately Correct policy that is produced.
2) Build (and validate) a linear model of the system in terms of feature vectors (the initiated linear function of steps 140, 240, 242 of methods 100, 200). Examples of linear model for the discrete-action case include a definition of the feature vectors ϕ (independent variable) in terms of the outer product of the context x and the action a, i.e. ϕ_{x,a}=x⊗a, where a∈{e₁, . . . , e_{d}} is the standard basis for R^{d}. The coefficient vector θ of the linear model is an unknown vector representing the mapping from feature vectors to rewards. The validation step, if carried out, may be executed at the beginning or the end of the training procedure based on the availability of offline data. Validation may be executed by fitting the linear model to the reward to a performance function and checking a fitness score for regression such as Mean Squared Error (MSE) or R-squared (also known as coefficient of determination).
   Steps 3 to 5 are then carried out either substantially continually as data is produced by the reference or logging policy, or off-line on a batch of data from the reference policy, until a stopping condition is fulfilled (steps 120, 130 of the methods 100, 200).
3) Observe the context samples from a context xₜ, produced by the environment (steps 130, 230 of the methods 100, 200).
4) Sample the action aₜ from the logging policy distribution a (steps 130, 230 of the methods 100, 200). The logging policy distribution may be of different kind to the policy distribution of the target policy to be determined.
5) Receive a reward sample from the environment rₜ (steps 130, 230 of the methods 100, 200).
6) Compute the Least Squares estimator of coefficient vector θ at current time t (steps 140, 240, 242) according to:

$${\hat{θ}}_{t} = {( {\sum }_{s = 1}^{t} {ϕ}_{{x}_{s} , {a}_{s}} {ϕ}_{{x}_{s} , {a}_{s}}^{T} )}^{- 1} ( {\sum }_{s = 1}^{t} {ϕ}_{{x}_{s} , {a}_{s}} {r}_{s} ) .$$

7) Check the stopping condition (steps 150, 250, 251-256 of the methods 100, 200). The stopping condition is based on the Chernoff stopping time, and is built with a statistical test based on the generalized log-likelihood ratio, which is defined as:

$${Z}_{a , b , ε}^{x} ( t ) = ( ( {ϕ}_{x , a} - {ϕ}_{x , b} ) + ε ) \frac{{( ( {ϕ}_{x , a} - {ϕ}_{x , b} ) + ε )}^{2}}{2 {( {ϕ}_{x , a} - {ϕ}_{x , b} )}^{T} {( {\sum }_{s = 1}^{t} {ϕ}_{{x}_{s} , {a}_{s}} {ϕ}_{{x}_{s} , {a}_{s}}^{T} )}^{- 1} ( {ϕ}_{x , a} - {ϕ}_{x , b} )}$$

$$and$$

$${Z}^{x} ( t ) = {max}_{a ∈ 𝒜} {min}_{b ∈ 𝒜 \backslash \{ a \}} {Z}_{a , b}^{x} ( t )$$

The generalized log-likelihood ratio Z_{a,b,ε}^{x}(t) may be envisaged as defining a statistical test that answers the question of whether the past observations (xₜ, aₜ, rₜ) are sufficient to be able to decide if one action a is better than all other actions b by at least ε and with confidence δ.
The stopping condition uses the above defined Z^{x}(t) and is designed as:

$$T = inf \{ t ∈ {N}^{+ +} : ∀ x ∈ 𝒳 , {Z}^{x} ( t ) > β ( δ , t ) and {\sum }_{s = 1}^{t} {ϕ}_{{x}_{s} , {a}_{s}} {ϕ}_{{x}_{s} {a}_{s}}^{T} ⪰ {cI}_{d}$$

where τ is the stopping time, that is the time at which the stopping condition is fulfilled (steps 160, 260 of the methods 100, 200).
The exploration threshold β(δ, t) for the stopping condition is defined as:

$$β ( δ , t ) = ( 1 + u ) log ( \frac{{det ( {( uc )}^{- 1} {\sum }_{s = 1}^{t} {ϕ}_{{x}_{s} , {a}_{s}} {ϕ}_{{x}_{s} , {a}_{s}}^{T} + {I}_{a} )}^{\frac{1}{2}}}{δ} )$$

where and c, u are two positive real constants and I_{d} denotes the identity matrix of dimension d.
The constant c is the constant multiple referred to above in the description of the method 200, and can be selected according to operational priorities. Example options for the constant c include:

$$c = {max}_{x ∈ X , a ∈ A} {‖ {ϕ}_{x , a} ‖}^{2}$$

where ∥ ∥ is the Euclidean norm. An example option for the constant u is u=1.
It will be appreciated that the exploration threshold β(δ, t) is designed in such a way that the probability of selecting an action that is more than epsilon-away from the best action is smaller than delta.
It can be proved that the stopping rule defined above ensures that the algorithm is optimal, that is it achieves in expectation the lower bound on the sample complexity.
8) Return the best estimated policy at time τ (steps 170, 270 of the methods 100, 200) according to the decision rule:

$${\hat{a}}_{τ} ( x ) = arg {max}_{a ∈ 𝒜} {\hat{θ}}_{τ}^{T} {ϕ}_{x , a} .$$

As discussed above, the methods 100 and 200 may be performed by a policy node, and the present disclosure provides a policy node that is adapted to perform any or all of the steps of the above discussed methods. The policy node may be a physical or virtual node, and may for example comprise a virtualized function that is running in a cloud, edge cloud or fog deployment. The policy node may for example comprise or be instantiated in any part of a logical core network node, network management center, network operations center, Radio Access node etc. Any such communication network node may itself be divided between several logical and/or physical functions, and any one or more parts of the management node may be instantiated in one or more logical or physical functions of a communication network node.

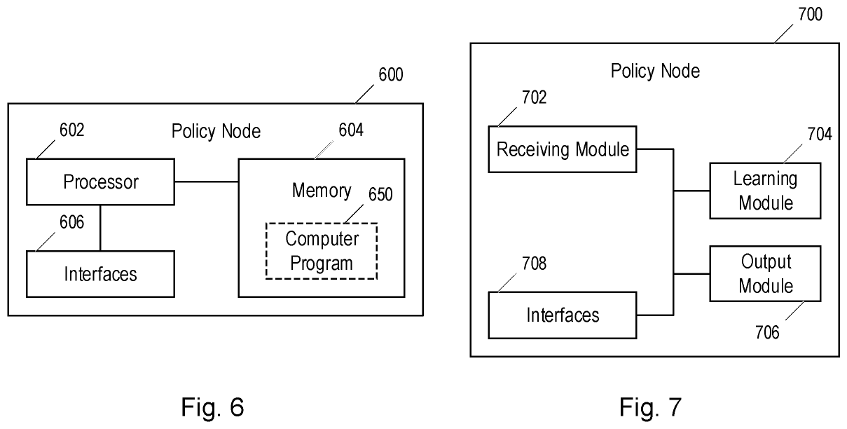

FIG. 6 is a block diagram illustrating an example policy node 600 which may implement the method 100 and/or 200, as illustrated in FIGS. 1 to 3, according to examples of the present disclosure, for example on receipt of suitable instructions from a computer program 650. Referring to FIG. 6, the policy node 600 comprises a processor or processing circuitry 602, and may comprise a memory 604 and interfaces 606. The processing circuitry 602 is operable to perform some or all of the steps of the method 100 and/or 200 as discussed above with reference to FIGS. 1 to 3. The memory 604 may contain instructions executable by the processing circuitry 602 such that the policy node 600 is operable to perform some or all of the steps of the method 100 and/or 200, as illustrated in FIGS. 1 to 3. The instructions may also include instructions for executing one or more telecommunications and/or data communications protocols. The instructions may be stored in the form of the computer program 650. In some examples, the processor or processing circuitry 602 may include one or more microprocessors or microcontrollers, as well as other digital hardware, which may include digital signal processors (DSPs), special-purpose digital logic, etc. The processor or processing circuitry 602 may be implemented by any type of integrated circuit, such as an Application Specific Integrated Circuit (ASIC), Field Programmable Gate Array (FPGA) etc. The memory 604 may include one or several types of memory suitable for the processor, such as read-only memory (ROM), random-access memory, cache memory, flash memory devices, optical storage devices, solid state disk, hard disk drive etc.

FIG. 7 illustrates functional modules in another example of policy node 700 which may execute examples of the methods 100 and/or 200 of the present disclosure, for example according to computer readable instructions received from a computer program. It will be understood that the modules illustrated in FIG. 7 are functional modules, and may be realized in any appropriate combination of hardware and/or software. The modules may comprise one or more processors and may be integrated to any degree.

Referring to FIG. 7, the policy node 700 is for determining a target policy for managing an environment that is operable to perform a task. The policy node 700 comprises a receiving module 702 for obtaining a training dataset comprising records of task performance by the environment during a period of management according to a reference policy, wherein each record of task performance comprises an observed context for the environment, an action selected for execution in the environment by the reference policy on the basis of the observed context, and a reward value indicating an observed impact of the selected action on task performance by the environment. The policy node 700 further comprises a learning module 704 for repeating, at a plurality of time steps until a stopping condition is satisfied, the steps of (i) selecting a record of task performance from the training data set, (ii) using the observed context, selected action, and reward from the selected record to update an initiated estimate of a linear function mapping observed context and selected action to a predicted value of reward, and (iii) checking whether the stopping condition has been satisfied. The learning module 704 may comprise a selection module 704a, an updating module 704b and a stopping module 704c to carry out the individual steps (i), (ii), and (iii) respectively. The stopping condition comprises the probability that an error condition for the linear function is satisfied descending below a maximum acceptability probability threshold. The error condition comprises an action selected using the current estimate of the linear function being separated by more than an error threshold from an optimal action. The policy node further comprises an output module 706 for outputting as the target policy a function operable to select for execution in the environment an action which, for a given context, is mapped by the estimate of the linear function at the time the stopping condition is satisfied to the maximum predicted value of reward. The policy node 700 may further comprise interfaces 708 which may be operable to facilitate communication with a management node, and/or with other communication network nodes over suitable communication channels.

As discussed above, the method 400 may be performed by a management node, and the present disclosure provides a management node that is adapted to perform any or all of the steps of the above discussed method. The management node may be a physical or virtual node, and may for example comprise a virtualized function that is running in a cloud, edge cloud or fog deployment. The management node may for example comprise or be instantiated in any part of a logical core network node, network management center, network operations center, Radio Access node etc. Any such communication network node may itself be divided between several logical and/or physical functions, and any one or more parts of the management node may be instantiated in one or more logical or physical functions of a communication network node.

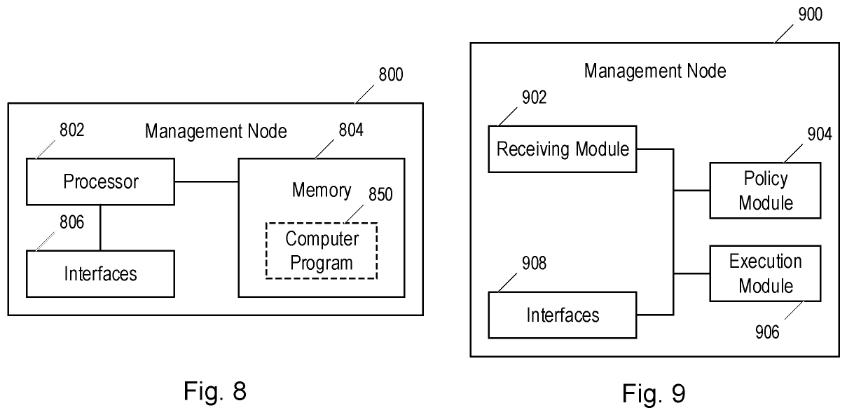

FIG. 8 is a block diagram illustrating an example management node 800 which may implement the method 400, as illustrated in FIGS. 4 and 3, according to examples of the present disclosure, for example on receipt of suitable instructions from a computer program 850. Referring to FIG. 8, the management node 800 comprises a processor or processing circuitry 802, and may comprise a memory 804 and interfaces 806. The processing circuitry 802 is operable to perform some or all of the steps of the method 400 as discussed above with reference to FIGS. 4 and 3. The memory 804 may contain instructions executable by the processing circuitry 802 such that the management node 800 is operable to perform some or all of the steps of the method 400, as illustrated in FIGS. 4 and 3. The instructions may also include instructions for executing one or more telecommunications and/or data communications protocols. The instructions may be stored in the form of the computer program 850. In some examples, the processor or processing circuitry 802 may include one or more microprocessors or microcontrollers, as well as other digital hardware, which may include digital signal processors (DSPs), special-purpose digital logic, etc. The processor or processing circuitry 802 may be implemented by any type of integrated circuit, such as an Application Specific Integrated Circuit (ASIC), Field Programmable Gate Array (FPGA) etc. The memory 804 may include one or several types of memory suitable for the processor, such as read-only memory (ROM), random-access memory, cache memory, flash memory devices, optical storage devices, solid state disk, hard disk drive etc.

FIG. 9 illustrates functional modules in another example of management node 900 which may execute examples of the method 400 of the present disclosure, for example according to computer readable instructions received from a computer program. It will be understood that the modules illustrated in FIG. 9 are functional modules, and may be realized in any appropriate combination of hardware and/or software. The modules may comprise one or more processors and may be integrated to any degree.

Referring to FIG. 9, the management node 900 is for using a target policy to manage an environment that is operable to perform a task. The management node comprises a receiving module 902 for obtaining the target policy from a policy node, wherein the target policy has been determined using a method according to the present disclosure. The receiving module 902 is also for receiving an observed environment context from an environment node. The management node further comprises a policy module 904 for using the target policy to select, based on the received observed context and from a set of possible actions for the environment, an action for execution in the environment. The target policy selects the action that is predicted to cause the highest or greatest reward value to be observed in the environment, the reward value comprising an observed impact of the selected action on task performance by the environment. The management node further comprises an execution module 906 for causing the selected action to be executed in the environment. The management node 900 may further comprise interfaces 908 which may be operable to facilitate communication with a policy node and/or with other communication network nodes over suitable communication channels.

There now follows a discussion of some example use cases for the methods of the present disclosure, as well as description of implementation of the methods of the present disclosure for such example use cases. It will be appreciated that the use cases presented herein are not exhaustive, but are representative of the situation which may be addressed using the methods presented herein.

Within the domain of communication networks, many of the most suitable use cases for the methods disclosed herein may be considered to fall within the category of “network parameter optimization” problems.

### Use Case 1: Remote Electrical Tilt Optimization

Modern cellular networks are required to satisfy consumer demand that is highly variable in both the spatial and the temporal domains. In order to be able efficiently to provide high level of Quality of Service (QoS) to User Equipments (UEs), networks must adjust their configuration in an automatic and timely manner. Antenna vertical tilt angle, referred to as downtilt angle, is one of the most important variables to control for QoS management. The downtilt angle can be modified both in a mechanical and an electronic manner, but owing to the cost associated with manually adjusting the downtilt angle, Remote Electrical Tilt (RET) optimization is used in the vast majority of modern networks.

The antenna downtilt is defined as the elevation angle of the main lobe of the antenna radiation pattern with respect to the to the horizontal plane. Several Key Performance Indicators (KPIs) may be taken into consideration when evaluating the performance of a RET optimization strategy, including coverage (area covered in terms of a minimum received signal strength), capacity (average total throughput in the a given area of interest), and quality. There exists a trade-off between coverage and capacity when determining an increase in antenna downtilt: increasing the downtilt angle correlates with a stronger signal in a more concentrated area, as well as higher capacity and reduced interference radiation towards other cells in the network. However, excessive downtilting can result in insufficient coverage in a given area, with some UEs unable to receive a minimum signal quality.

In the following discussion, the focus is on Capacity Coverage Optimization (CCO), which seeks to optimize coverage and capacity jointly, maximizing the network capacity while ensuring that the targeted service areas remain covered. It is assumed that a reference dataset is available, generated according to a reference policy that may be rule-based and designed by a domain expert or may be a data driven policy. In the following example, the reference policy is the is the rule-based policy introduced by V. Buenestado, M. Toril, S. Luna-Ramirez, J. M. Ruiz-Aviles and A. Mendo, in the paper “Self-tuning of Remote Electrical Tilts Based on Call Traces for Coverage and Capacity Optimization in LTE,” IEEE Transactions on Vehicular Technology, vol. 66, no. 5, pp. 4315-4326, May 2017. The reference policy is assumed to be suboptimal and consequently improvable.

For the purposes of the present use case, the following elements may be defined:

Environment: The physical 4G or 5G mobile cellular network area considered for RET optimization. The network area may be divided into C sectors, each served by an antenna.

Context: A set of normalized KPIs collected in the area considered for the RET optimization. The context x_{t,c}=[1, {KPI_{I}(t, c)}ᵢ₌₁ⁿ]⊆[0,1]ⁿ⁺¹ consists of a set of n normalized KPIs modeling coverage and capacity of cell c at time t, plus a constant offset term. In one example, the context may be described by the vector sₜ=[cov(t), cap(t), ε(t)]∈[0,1]×[0,1]×[0,90] where cov(t) is the coverage network metric, cap(t) is the capacity metric and D(t) is the downtilt of an antenna at time t.

Action: A discrete change in the current antenna tilt angle. The action of cell c at time t a_{t,c} is chosen from a 3-dimensional action space:

$$𝒜 = \{ {e}_{1} , {e}_{2} , {e}_{3} \} = \{ [ 1 , 0 , 0 ] , [ 0 , 1 , 0 ] , [ 0 , 0 , 1 ] \}$$

and comprises uptilting or downtilting the antenna by a discrete amount, or keeping the same tilt. It is assumed that actions are sampled from the reference policy a_{t,c}˜αₓ_{_{t,c}}.

Reward: A measure of the context variation induced by the action a₁ taken given the context xᵢ. The reward signal or function may be defined at the level of domain knowledge.

Referring to the method 200 and the process flow of FIG. 5, the exploration threshold constants are initialized to c=1, u=0.1.

The independent variable feature vectors are defined by the outer product between a context-action pair ϕₓ_{_{t,c}}ₐ_{_{t,c}}=vec(x_{t,c}⊗a_{t,c})∈R³⁽ⁿ⁺¹⁾.

The average reward is modeled by fitting a linear model θ to a performance function measuring the change in performance of the KPIs:

$${f}_{p} ( t , c ) = {\sum }_{i = 1}^{n} {b}_{i} ( {KPI}_{i} ( t + 1 , c ) - {KPI}_{i} ( t , c ) )$$

where the constants bᵢ∈R for i∈[n], are tunable parameters controlling the importance of the respective KPIs on the network performance. These constants may for example be tuned by network operators based on their preference.

The present example focusses on two KPIs: cell overshooting N_{OS}(t, c) that detects problems for cell capacity, and bad coverage indicator R_{BC}(t, c) that detects problems with cell coverage in the cell based on Reference Signal Received Power (RSRP) measurements. N_{OS}(t, c) and R_{BC}(t, c) are defined in equations (1) and (4) respectively of the paper by Buenestado et al. cited above.

### Experimental Validation

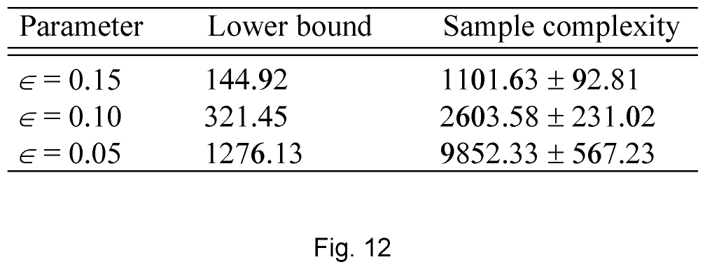

To perform experiments, a dataset of T=92990 samples was collected and processed sequentially according to the method 200, as implemented by the process flow of FIG. 5. The processing of the samples was consequently halted when the stopping condition was fulfilled, and the best estimate policy at that time was obtained. This procedure was repeated for the whole of the collected dataset, and the results in terms of mean and standard deviation are reported the table illustrated in FIG. 12 (discussed below).

The performance function was computed with b₁=−1, b₂=−½, and the reward fitting achieves a Mean Squared Error (MSE) on the test set of MSE=0.004350. FIG. 10 illustrates samples of fitting curves on 100 points of the test set, comparing the performance function ƒₚ(t, c) to the linear model r_{t,c} with the estimate of the coefficient vector θ output at the time the stopping condition was fulfilled.

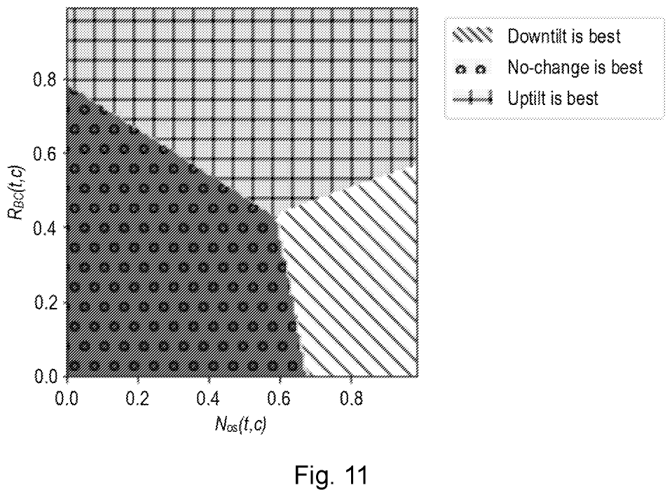

FIG. 11 illustrates the optimal action as proposed by the best estimate target policy at the stopping time (based on the linear model and its coefficient vector at the stopping time). FIG. 11 illustrates the action proposed by the policy according to variations in the context elements of N_{OS}(t, c) and R_{BC}(t, c) introduced above.

It can be observed from FIG. 11 that when both N_{OS}(t, c) and R_{BC}(t, c) are low (i.e. there is an acceptable level of coverage and capacity in the cell), the no-change action is predicted by the target policy to be the best. This is consistent with an expert led decision as no problems in coverage or capacity are detected. When N_{OS}(t, c) is high (i.e., there is a problem with capacity of the cell), the downtilt action is predicted by the target policy to be the best. On the contrary, when R_{BC}(t, c) is high (i.e., there is a problem in with coverage of the cell) the uptilt action is predicted to be the best. Again, these predictions are consistent with a domain level understanding of the situation in the cell.

The table in FIG. 12 shows results for the Lower bound and sample complexity for the experimental validation, with a value of δ=0.1 and with different values of ε as indicated. It can be seen from FIG. 13 at each value of ε, the process of the experiment achieves within multiplicative constant of the theoretical lower bound on sample complexity.

According to one example of the present disclosure, there is provided a computer implemented method for determining a target policy for managing Remote Electronic Tilt (RET) in at least a sector of a cell of a communication network, which cell sector is operable to provide Radio Access Network (RAN) services for the communication network, the method, performed by a policy node, comprising:
obtaining a training dataset comprising records of RAN service provision performance by the cell sector during a period of management according to a reference policy, wherein each record of performance comprises an observed context for the cell sector, an action selected for execution in the cell sector by the reference policy on the basis of the observed context, and a reward value indicating an observed impact of the selected action on RAN service provision performance by the cell sector;
repeating, at a plurality of time steps until a stopping condition is satisfied, the steps of:
   selecting a record of performance from the training data set;
   using the observed context, selected action, and reward from the selected record to update an initiated estimate of a linear function mapping observed context and selected action to a predicted value of reward; and
   checking whether the stopping condition has been satisfied;
      the method further comprising:
outputting as the target policy a function operable to select for execution in the cell sector an action which, for a given context, is mapped by the estimate of the linear function at the time the stopping condition is satisfied to the maximum predicted value of reward;
wherein the stopping condition comprises the probability that an error condition for the linear function is satisfied descending below a maximum acceptability probability threshold;
and wherein the error condition comprises an action selected using the current estimate of the linear function being separated by more than an error threshold from an optimal action.

According to another aspect of the present disclosure, there is provided a computer implemented method for using a target policy to manage Remote Electronic Tilt (RET) in at least a sector of a cell of a communication network, which cell sector is operable to provide Radio Access Network (RAN) services for the communication network, the method, performed by a management node, comprising:
obtaining the target policy from a policy node, wherein the target policy has been determined using a method according to examples of the present disclosure;
receiving an observed cell sector context from a communication network node;
using the target policy to select, based on the received observed context and from a set of possible actions for the cell sector, an action for execution in the cell sector; and
causing the selected action to be executed in the cell sector;
wherein the target policy selects the action that is predicted to cause the highest reward value to be observed in the cell sector, the reward value comprising an observed impact of the selected action on RAN service provision performance by the cell sector.

For the purpose of the methods disclosed immediately above and relating to management of RET in at least a cell sector of a communication network, an observed cell sector context comprises at least one of:
a coverage parameter for the sector;
a capacity parameter for the sector;
a signal quality parameter for the sector;
a down tilt angle of the antenna serving the sector;
   and an action for execution in the cell sector comprises a downtilt adjustment value for an antenna serving the sector.

### Use Case 1bis: Base Station Parameter Optimization

It will be appreciated that RET is merely one of many operational parameters for communication network cells. For example, a radio access node, such as a base station, serving a communication network cell may adjust its transmit power, required Uplink power, sector shape, etc., so as to optimize some measure of cell performance, which may be represented by a combination of cell KPIs. The methods and nodes of the present disclosure may be used to manage any operational parameter for a communication network cell.

### Use Case 2: Dynamic Resource Allocation

In many communication networks, a plurality of services may compete over resources in a shared environment such as a Cloud. The services can have different requirements and their performance may be indicated by their specific QoS KPIs. Additional KPIs that can be similar across services can also include time consumption, cost, carbon footprint, etc. The shared environment may also have a list of resources that can be partially or fully allocated to services. These resources can include CPU, memory, storage, network bandwidth, Virtual Machines (VMs), Virtual Network Functions (VNFs), etc.

For the purposes of the present use case, the following elements may be defined:

Environment: The cloud, edge cloud or other shared resource platform over which services are provided, and within which the performance of the various services with their current allocated resources may be monitored.

Context: A set of normalized KPIs for the services deployed on the shared resource of the environment.

Action: An allocation or change in allocation of a resource to a service.

Reward: A measure of the context variation induced by an executed action given the context. This may comprise a function or combination of KPIs for the services.

### Use Case 3: Industrial Process Optimization

A wide range of industrial processes are subject to control measures to ensure that the process is executed in an optimal manner. Such control may include environmental control measures such as temperature, pressure, humidity, chemical composition of the atmosphere, etc. Control may also include management of flow rates, machine component position, motion, etc. The outcome of such processes can be measured via various process KPIs appropriate to the specific sector and process.

For the purposes of the present use case, the following elements may be defined:

Environment: The process platform in or on which the process is carried out, including for example any machinery involved in the process.

Context: A set of normalized KPIs or other monitoring measures for the process and/or its outcome.

Action: A setting or change in setting of a process parameter.

Reward: A measure of the context variation induced by an executed action given the context. This may comprise a function or combination of KPIs or monitoring measures.

### Use Case 4: Vehicle Control

A self-driving vehicle may be required to maintain control over many aspects of its functioning and interaction with the environment in which it is located, For example, a vehicle may be required to handle navigation and collision avoidance, as well as managing its internal systems including engine control, steering, etc. Examples of the present disclosure may be used to train a policy for managing any aspect of the vehicle as it advances over a terrain. As illustrated at 310iii, in another example, the environment may comprise a vehicle, and the task that the environment is operable to perform may comprise advancing over a terrain. In such examples, the system controlling the environment may comprise a vehicle navigation system, collision avoidance system, engine control system, steering system etc.

For the purposes of the present use case, the following elements may be defined:

Environment: The vehicle itself and/or the physical environment through which the vehicle is moving.

Context: A set of normalized KPIs and/or other monitoring measures for the vehicle and/or its motion. This may include for example engine temperature, fuel level etc., as well as speed geographic location, or other measures.

Action: A setting or change in setting of any parameter controlling operation of the vehicle. This may include for example a change to the direction of travel implemented via an actuation within the steering system, a change in required speed, flow of cooling fluid, etc.

Reward: A measure of the context variation induced by an executed action given the context. This may comprise a function or combination of KPIs for the services.

It will be appreciated that a wide range of additional use cases for methods according to the present disclosure may be envisaged. For example, target policies for control of environments in industrial, manufacturing, commercial, residential, computer networking, and energy generation sectors may be generated using methods according to the present disclosure.

Examples of the present disclosure those propose an optimal off-policy (ε, δ)-PAC algorithm for identifying the best policy of any task modeled as a Linear Contextual Bandit problem. The methods disclosed herein offer advantages in terms of safety, in that an optimal policy can be determined based on the interaction of a reference policy with the environment. Exploratory actions that may result in performance that is worse than that achieved by a deployed baseline policy, and may in some cases be classed as unsafe for the particular environment, are completely avoided. The methods disclosed herein also offer advantages in optimality, in that the proposed process is provably optimal in terms of sample complexity, i.e., it achieves up to a multiplicative constant the theoretical lower bound on the sample complexity of any (ε, δ)-PAC algorithm.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims or numbered embodiments. The word “comprising” does not exclude the presence of elements or steps other than those listed in a claim or embodiment, “a” or “an” does not exclude a plurality, and a single processor or other unit may fulfil the functions of several units recited in the claims or numbered embodiments. Any reference signs in the claims or numbered embodiments shall not be construed so as to limit their scope.

1. A computer implemented method for determining a target policy for managing an environment that is operable to perform a task, the method, performed by a policy node, comprising:
obtaining a training dataset comprising records of task performance by the environment during a period of management according to a reference policy, wherein each record of task performance comprises an observed context for the environment, an action selected for execution in the environment by the reference policy on the basis of the observed context, and a reward value indicating an observed impact of the selected action on task performance by the environment;
repeating, at a plurality of time steps until a stopping condition is satisfied, the steps of:
selecting a record of task performance from the training data set;
using the observed context, selected action, and reward from the selected record to update an initiated estimate of a linear function mapping observed context and selected action to a predicted value of reward; and
checking whether the stopping condition has been satisfied;
the method further comprising:
outputting as the target policy a function operable to select for execution in the environment an action which, for a given context, is mapped by the estimate of the linear function at the time the stopping condition is satisfied to the maximum predicted value of reward;
wherein the stopping condition comprises the probability that an error condition for the linear function is satisfied descending below a maximum acceptability probability threshold;
and wherein the error condition comprises an action selected using the current estimate of the linear function being separated by more than an error threshold from an optimal action.

2. The method as claimed in claim 1, wherein the obtained records of task performance comprise a sequential time series of individual records, and wherein selecting a record of task performance from the training data set comprises selecting a next record in the time series.

3. The method as claimed in claim 1, wherein using the observed context, selected action, and reward from the selected record to update an initiated estimate of a linear function mapping observed context and selected action to a predicted value of reward comprises:
using a Least Squares estimator to update the initiated estimate of the linear function.

4. The method as claimed in claim 1, wherein the linear function mapping observed context and selected action to a predicted value of reward comprises an independent variable vector that is a function of the observed context and selected action, and a coefficient vector of the independent variable vector; and wherein using the observed context, selected action, and reward from the selected record to update an initiated estimate of the linear function comprises:
calculating an estimated value of the coefficient vector using values of the independent variable vector and the reward from the currently selected and previously selected records of task performance.

5. The method as claimed in claim 3, wherein calculating an estimated value of the coefficient vector comprises:
calculating a first summation, over the currently selected and all previously selected records of task performance, of the outer product of the independent variable vector and the reward value from each record of task performance;
calculating a second summation, over the currently selected and all previously selected records of task performance, of the product of the independent variable and its transpose from each record of task performance; and
dividing the first summation by the second summation.

6. The method as claimed in claim 1, wherein checking whether the stopping condition has been satisfied comprises:
calculating a degree of certainty with which the current and previously selected records enable a determination, using the current updated estimate of the linear function, that any one possible action for execution in the environment is better than any other of the possible actions for execution in the environment by at least the error threshold;
calculating a value of an exploration function that is based on the maximum acceptability probability threshold and a summation, over the currently selected and all previously selected records of task performance, of the product of the independent variable and its transpose from each record of task performance; and
comparing the calculated degree of certainty to the calculated value of the exploration function.

7. The method as claimed in claim 6, wherein calculating the degree of certainty comprises calculating a generalized log likelihood ratio using the current updated estimate of the linear function.

8. The method as claimed in claim 6, wherein the stopping condition is satisfied when the calculated degree of certainty exceeds the calculated value of the exploration function.

9. The method as claimed in claim 6, wherein the stopping condition is satisfied when:
the calculated degree of certainty exceeds the calculated value of the exploration function; and
a positive partial ordering is satisfied between a summation, over the currently selected and all previously selected records of task performance, of the product of the independent variable and its transpose from each record of task performance, and a constant multiple of the identity matrix.

10. The method as claimed in claim 6, wherein a stopping time at which the stopping condition is satisfied comprises the infimum of:
a subset comprising time steps at which the calculated degree of certainty exceeds the calculated value of the exploration function, for a containing set of all positive time steps; and
wherein a positive partial ordering is satisfied between a summation, over the currently selected and all previously selected records of task performance, of the product of the independent variable and its transpose from each record of task performance, and a constant multiple of the identity matrix.

11. The method as claimed in claim 1, further comprising:
initiating an estimate of the linear function.

12. The method as claimed in claim 1, further comprising:
validating the linear function against a performance function for the environment.

13. The method as claimed in claim 12, wherein validating the linear function against a performance function for the environment comprises:
fitting the linear function to the performance function for the environment.

14. The method as claimed in claim 1, wherein the environment comprises at least one of a cell of a communication network, a cell sector of a communication network, at least a part of a core network of a communication network, or a slice of a communication network, and wherein the task that the environment is operable to perform comprises provision of communication network services.

15. The method as claimed in claim 1, wherein an observed environment context in the training dataset comprises at least one of:
a value of a network coverage parameter;
a value of a network capacity parameter;
a value of a network congestion parameter;
a value of a network quality parameter;
a current network resource allocation;
a current network resource configuration;
a current network usage parameter;
a current network parameter of a neighbor communication network cell;
a value of a network signal quality parameter;
a value of a network signal interference parameter;
a value of a Reference Signal Received Power, RSRP parameter;
a value of a Reference Signal Received Quality, RSRQ, parameter;
a value of a network signal to interference plus noise ratio, SINR, parameter;
a value of a network power parameter;
a current network frequency band;
a current network antenna down-tilt angle;
a current network antenna vertical beamwidth;
a current network antenna horizontal beamwidth;
a current network antenna height;
a current network geolocation; and
a current network inter-site distance.

16. The method as claimed in claim 1, wherein the reward value indicating an observed impact of the selected action on task performance by the environment comprises a function of at least one performance parameter for the communication network.

17. The method as claimed in claim 1, wherein an action for execution in the environment comprises at least one of:
an allocation decision for a communication network resource;
a configuration for a communication network node;
a configuration for communication network equipment;
a configuration for a communication network operation;
a decision relating to provision of communication network services for a wireless device; and
a configuration for an operation performed by a wireless device in relation to the communication network.

18. The method as claimed in claim 1, wherein the environment comprises a sector of a cell of a communication network and wherein the task that the environment is operable to perform comprises provision of radio access network services;
wherein an observed environment context in the training dataset comprises at least one of:
a coverage parameter for the sector,
a capacity parameter for the sector,
a signal quality parameter for the sector, and
a down tilt angle of the antenna serving the sector,
and wherein an action for execution in the environment comprises a down tilt adjustment value for an antenna serving the sector.

19. A computer implemented method for using a target policy to manage an environment that is operable to perform a task, the method, performed by a management node, comprising:
obtaining the target policy from a policy node, wherein the target policy has been determined using a method according to claim 1;
receiving an observed environment context from an environment node;
using the target policy to select, based on the received observed context and from a set of possible actions for the environment, an action for execution in the environment; and
causing the selected action to be executed in the environment;
wherein the target policy selects the action that is predicted to cause the highest reward value to be observed in the environment, the reward value comprising an observed impact of the selected action on task performance by the environment.

20. The method as claimed in claim 19, wherein using the target policy to select, based on the received observed context and from a set of possible actions for the environment, an action for execution in the environment comprises:
using a reward estimator to estimate a reward from taking each possible action given the received context; and
selecting for execution in the environment the action having the highest estimated reward.

21.-30. (canceled)
